(19) United States
(12) Patent Application Publication
(10) Pub. No.: US 2009/0228542 A1
(43) Pub. Date: Sep. 10, 2009

(54) OCCASIONALLY-CONNECTED SUPPORT THROUGH OFF-LINE SERVICE-SUPPLIED PROXIES

(75) Inventors: Henricus Johannes Maria Meijer, Mercer Island, WA (US); Dragos A. Manolescu, Kirkland, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/043,782

(22) Filed: Mar. 6, 2008

(51) Int. Cl. G06F 15/16

(52) U.S. Cl. 709/201

(57) ABSTRACT

A system is provided to facilitate service-oriented applications. The system includes one or more network accessible resources that are split into two or more application functions. A proxy component communicates over a network with the network accessible resources and executes a subset of the application functions during outages of the network.

### BACKGROUND

Increasingly, computer programming or coding is shifting away from single devices and toward distributed systems. Client/server architectures of the past have reemerged as a dominant computing paradigm thanks to advances in network communication as well the advent of the Internet. Moreover, development is moving toward software as a service (SaaS). For web applications software as a service (SaaS) is a delivery model where a software vendor develops a web-native software application and hosts and operates (either independently or through a third-party) the application for use by its customers over the Internet. Customers do not pay for owning the software itself but rather for using it. They use it through an application programming interface (API) accessible over the Web and often written using Web Services or other mechanisms. The term SaaS has become the industry preferred term, generally replacing the earlier terms Application Service Provider (ASP) and On-Demand. Here, applications are designed as network accessible services. More specifically, functionality that transcends a single application, and could thus be reused, is factored into services. Instead of implementing this functionality in their applications, developers consume these services thereby enabling them to focus on unique aspects of their respective developments.

As a term, SaaS is generally associated with business software and is typically thought of as a low-cost way for businesses to obtain the same benefits of commercially licensed, internally operated software without the associated complexity and high initial cost. Many types of software are well suited to the SaaS model, where customers may have little interest or capability in software deployment, but do have substantial computing needs. Application areas such as Customer Relations Management, Video Conferencing, Human Resources, Accounting and Email are just a few of the initial markets showing SaaS success. The distinction between SaaS and earlier applications delivered over the Internet is that SaaS solutions were developed specifically to leverage Web technologies such as the browser, thereby making them web-native.

The key characteristics of SaaS software, according to IDC, include: network-based access to, and management of, commercially available (i.e., not custom) software activities that are managed from central locations rather than at each customer's site, enabling customers to access applications remotely via the Web application delivery that typically is closer to a one-to-many model (single instance, multi-tenant architecture) than to a one-to-one model, including architecture, pricing, partnering, and management characteristics centralized feature updating, which obviates the need for downloadable patches and upgrades. Generally, SaaS applications are generally priced on a per-user basis, sometimes with a relatively small minimum number of users, and often with additional fees for extra bandwidth and storage. Thus, SaaS revenue streams to the vendor are therefore lower initially than traditional software license fees, but are also recurring, and therefore viewed as more predictable, much like maintenance fees for licensed software.

Service code supporting such SaaS architectures executes in environments different than where consumer code executes. Typically, the hardware capabilities differ sharply: services run on enterprise-class hardware optimized to serve large numbers of consumers. In contrast, the consumers run on a wide range of hardware with capabilities far below what is available on the service side. The platforms also differ, where the services and service consumers could run on platforms subject to very different design goals. For example, a service could run on a redundant, multi-processor host, while a service consumer could execute on a battery powered phone running a web browser. The segregation of service code has had a strong impact on how applications are designed, developed, tested and executed

Applications targeting mobile devices cannot assume that the devices are always connected. In occasionally-connected scenarios, the application must be able to operate even when it can't use the network, which translates into access to remote services. Because of this requirement, the shift towards service-oriented computing seems in conflict with mobility. Currently, service-centric applications that must support occasionally-connected scenarios cache service requests while disconnected and fulfill them when connected.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Multi-tiered service-based applications are supported where service functionality running on a host is shared with client applications to support occasionally-connected application scenarios. A service proxy operative on a client machine provides a subset of the behavior or functionality offered by the server-resident service (or network accessible resources) in the event the service should be disconnected from the client such as in a mobile computing or other wireless applications, for example. Thus, rather than merely caching data while the service is disconnected, the service proxy operating on the client can provide a subset of the service functionality at the client and thereby offering a higher level of service during periods of disconnection. When the service and proxy are reconnected, synchronization is provided between the proxy and the host service to update data with the service during disconnection and after the network has reconnected.

Intermittent network problems can be overcome by running a portion of service code at a browser or other client application. By splitting applications between the service and the client, this impacts how services are developed and executed in occasionally-connected scenarios, where services aimed at occasionally-connected applications provide code for an off-line proxy to the client. The developer of the client application no longer has to implement the caching of the requests during service outages. Rather, this is provided by the off-line proxy, which can also bring along local state and functionality that can allow for lower-fidelity operation while disconnected. Other features supported include load balancing between the client proxy and the service, automatic synchronization and switching between the client and the service during disconnections and reconnections, and the ability to provide application security where sensitive information is exchanged with the proxy and later transmitted to the service employing higher level security means.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a system for supporting occasionally-connected applications.

FIG. 2 is a block diagram that illustrates an example service and service proxy system.

FIG. 3 illustrates a flow diagram that describes multi-tiered application process.

FIG. 4 illustrates a flow diagram that describes a switching process between service and proxy applications.

FIG. 5 illustrates a flow diagram that describes a load balancing process between a service and service proxy application.

FIGS. 6-10 illustrate alternative system aspects for occasionally-connected network applications.

FIG. 11 is a schematic block diagram illustrating a suitable operating environment.

FIG. 12 is a schematic block diagram of a sample-computing environment.

### DETAILED DESCRIPTION

Systems and methods are provided for supporting occasionally-connected applications. In one aspect, a system is provided to facilitate network applications. The system includes one or more network accessible resources that are split into two or more application functions. A proxy component communicates over a network with the network accessible resources and executes a subset of the application functions during outages of the network.

As used in this application, the terms “component,” “service,” “engine,” “proxy,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

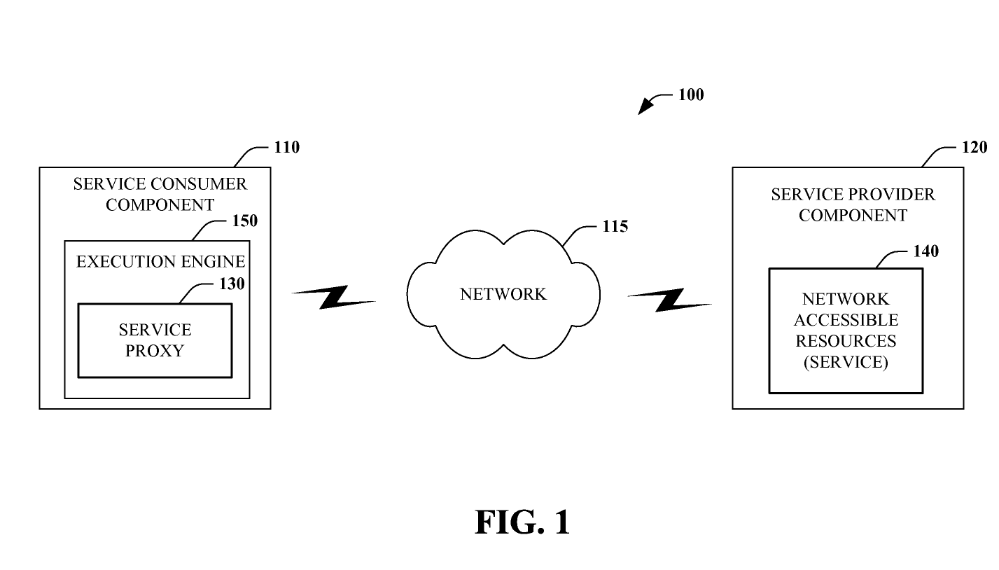

Referring initially to FIG. 1, a system 100 is illustrated for supporting occasionally-connected applications. As illustrated, a service consumer component 110 and a service provider component 120 are communicatively coupled by a network 115. The service consumer component 110 is operable to consume or interact with a service supplied by the service provider component 120. According to one aspect, the service consumer component 110 can correspond to a client and the service provider component a server in a client/server architecture. The network 115 provides a consumer-provider communication path in wired or wireless applications. In one instance, the network can correspond to the Internet for example.

In one aspect, multi-tiered service applications are supported where service functionality running on the service provider component 120 is shared with client applications to support occasionally-connected application scenarios. A service proxy 130 operative on the service consumer component 110 provides a subset of the behavior or functionality offered by one or more network accessible resources 140 (also referred to as a service 140) in the event the resources or service should be disconnected from the client such as in a mobile computing or other wireless applications, for example. Thus, rather than merely caching data while the service 140 is disconnected, the service proxy 130 operating on the client can provide a subset of the service functionality at the client and thereby offering a higher level of service during periods of disconnection. When the service 140 and service proxy 130 are reconnected, synchronization is provided between the proxy and the host service to update data with the service during disconnection and after the network 115 has reconnected.

Intermittent network problems can be overcome by running a portion of service code at a browser or other client application as will be described in more detail below. The splitting of applications between the service 140 and the service proxy 130 impacts how services are developed and executed in occasionally-connected scenarios, where services targeted at occasionally-connected applications provide code for an off-line proxy to the client. Thus, the developer of the client application no longer has to implement the caching of the requests during service outages. Rather, this is provided by the service proxy 130 that has been automatically generated by the service provider 120, which can bring along local state and functionality that can allow for lower-fidelity operation while disconnected. Other features supported include load balancing between the service proxy 130 and the service 140, automatic synchronization and switching between the client and the service during disconnections and reconnections, and the ability to provide application security where sensitive information is exchanged with the proxy and later transmitted to the service employing higher level security means.

The service proxy 130 can be executed by execution engine 150. This can correspond to any runtime or execution environment supported by the service consumer component 110. However, in accordance with on aspect, the execution engine 150 can be a web browser. In this case, all that is required to initiate the proxy 130 is navigating to a particular web address. Subsequently, the service 112 or a proxy service can be loaded in the browser, which triggers and is responsive to the service 140.

An additional benefit of the system 100 relates to confidentiality of data on both the provider and consumer side. On the provider side 120, internal data is unknown to consumers. In some instances, there may be something sensitive about the data, data access, communication, etc. that is desired to be kept confidential. By housing the data on the provider rather than the consumer, this information can remain confidential. On the consumer side, the service proxy 130 can employ consumer data without exposing it across the network 115 or to the associated provider. For example, if there are many amendments on an insurance policy and the identity of the related individual and the amendments themselves are considered confidential, the service proxy 130 can pull this information from a consumer database such that the service 140 is unaware of the particulars of the data. Thus, the service shipped to the consumer, rather than the provider, can access data to which it would not have had access otherwise. After transactions have been completed, confidential data can be exchanged between the service proxy 130 and service 140 via security mechanisms such as encrypted data, encrypted channels or secure sockets, and other means. Such data can be transferred during background operations or other periods that are transparent to the client. In another aspect, a network communications system is provided. This includes means for providing one or more services (network accessible resources 140) and means for interacting remotely with the services (service proxy 130). This can also include means for defining attributes of the services (specified within the underlying service 140 source code).

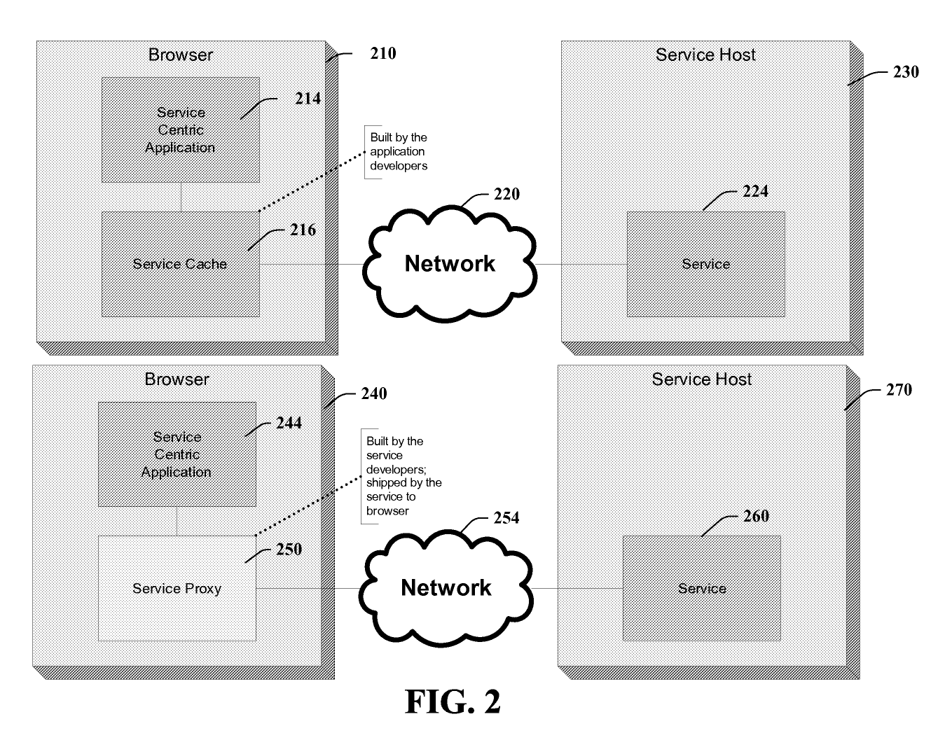

Referring now to FIG. 2, an example service and service proxy system is illustrated. Briefly, a prior art system is illustrated where a browser 210 supports a service centric application 214 that operates a cache 216 on the browser. The cache 216 communicates over a network 220 to a service 224 operating on a service host 230. Such system suffers several disadvantages. If the network 220 is disconnected, the service centric application 214 can only store data at the cache 216 until the network is reconnected and the data can be transferred to the service 224. The data cannot be processed or provide some semblance of the respective service 224 during the disconnection period. Another problem is that service centric application developer is forced to design the cache 216 when they have little knowledge of all the requirements of the service 224. Finally, the cache stores data but doesn't provide any functionality, such as an approximation of the functionality of the service 224.

According to the subject innovation, a browser 240 operates a service centric application 244 that in turn operates a service proxy 250 that is supplied over a network 254 by a service 260 operating on a service host 270. In this case, the service 260 has been split into tiers where a portion or subset of the service operates in the service proxy 250. During normal periods of network connectivity, the majority of operations are supplied by the service 260. During periods of network disconnection, and which are automatically detected, functionality of the service 260 can be provided in part by the service proxy 250. Moreover, the application developer is no longer responsible for designing and maintaining a service cache as in prior systems. Thus, the multi-tiered architecture reduces overhead on the application developers while providing control over what is cached and how data synchronization is achieved after reconnection of the network 254. This also provides the ability to push additional local state and behavior into the service proxy 250 and provide lower-fidelity processing results during network outages.

In one application example, a field insurance agent may be operating a service 260 where client data is exchanged to provide a quote for the potential purchase of insurance. Before all the data can be exchanged with the service, a network outage occurs. At this point, the service proxy can continue to collect customer data and can process data in perhaps a limited form or subset of service offered by the service 260. For example, a reduced quoting algorithm (less processing sophistication or functionality than underlying service) may be operative on the proxy 250 where a generalized insurance quote can be generated while the service 260 is disconnected. When the network 254 comes back up, customer data can be automatically re-synchronized with the service 260 and the service can generate a more detailed or accurate quote from the data collected by the proxy 250 during the outage. As can be appreciated, substantially any type of application can be split at the service 260 and executed as a subset of the respective service at the proxy 250.

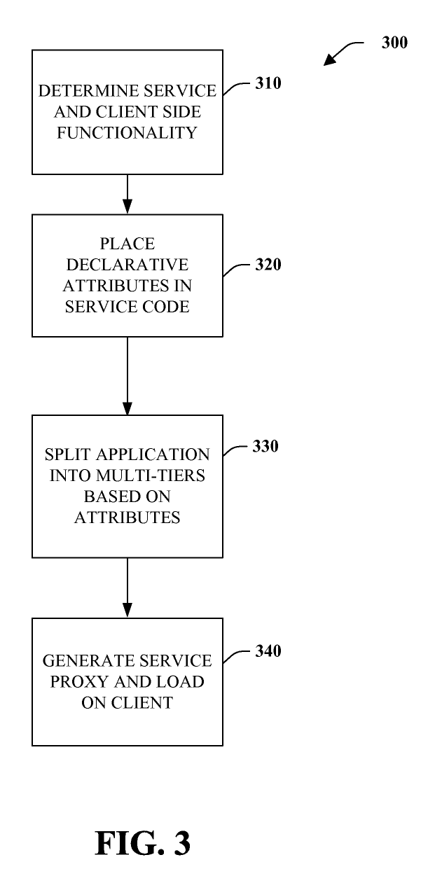

FIGS. 3-5 illustrate exemplary processes or methodologies for supporting network applications. While for purposes of simplicity of explanation, the processes are shown and described as a series or number of acts, it is to be understood and appreciated that the subject processes are not limited by the order of acts, as some acts may, in accordance with the subject processes, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

Referring to FIG. 3, a multi-tiered application process 300 is illustrated. At 310, service functionality is analyzed and determined. This includes determining what aspects of an application can be executed at the server, what aspects can be executed at the client proxy, and how responsibilities are shared during network disconnections and reconnections. This can include defining services as a set of interrelated functions where each of the respective functions can execute in a local environment on the service side or in a remote environment on the client proxy side. Thus, if ten functional components are designed for the overall service. Nine or less of the functional components could be allocated as a subset for the proxy side. Proceeding to 320, declarative attributes are placed in the service side code to indicate where service side functionality and proxy side functionality is defined for compile time of the service code. Thus at compile time, a full service side component will be generated along with a proxy that can operate a reduced subset of the service functionality.

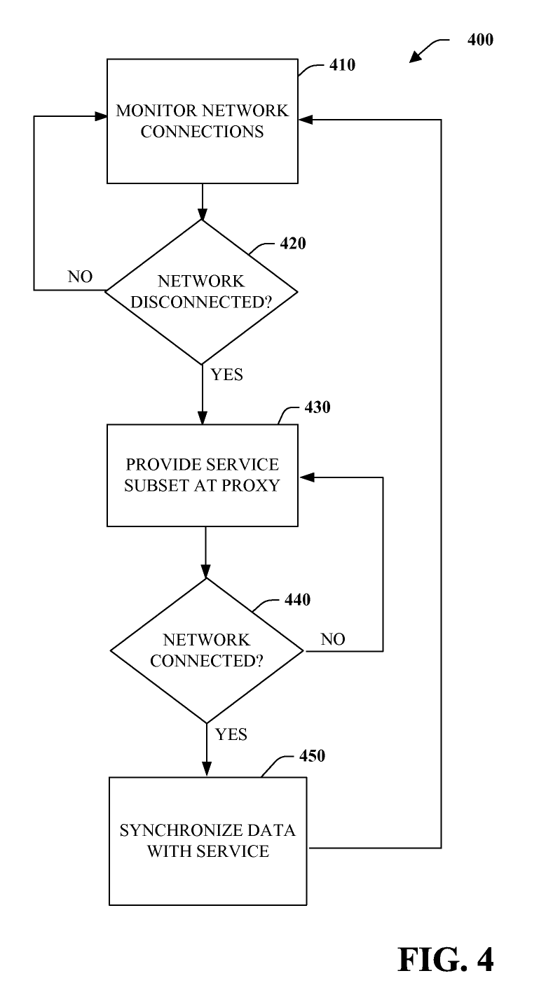

At 330, the service code is automatically split between service executable code and proxy executable code. Thus, when the declarative attributes are encountered by the compiler, a service executable module can be generated in accordance with the attributes and a proxy executable module can also be generated according to the defined attributes. At 330, the service proxy is generated and loaded onto the client. As will be described in more detail below with respect to FIG. 4, various handshaking and monitoring is provided to coordinate execution of the service and the proxy during periods of network outage and subsequent reconnection.

Turning to FIG. 4, a switching process 400 is illustrated between service and proxy applications. Proceeding to 410, network connections are monitored. At 420, a determination is made as to whether or not the network connection is still viable. If so, the process proceeds back to 410 and monitors the connections. If a network connection has been dropped at 420, the process proceeds to 430. At 430, the proxy component operating on the client side begins executing a subset of the full services offered by the service which can no longer be communicated with due to the network outage. This can include operating lower performance algorithms or a subset of service functions, caching data automatically for the client application, managing or operating states for the client, and continuing to monitor for communications with the service.

Proceeding to 440, a determination is made as to whether or not the network connection has become available. If not, the process proceeds back to 430, where the proxy continues to support the client side application. If the network has come back up at 430, the process proceeds to 450 and synchronizes data with the service. In this aspect, this includes sharing states, data collected, and any intermediate processing results or states determined by the proxy that may be useful to the service while it was offline. After the respective data exchange between the service and the proxy, the process proceeds back to 410 to monitor network activities.

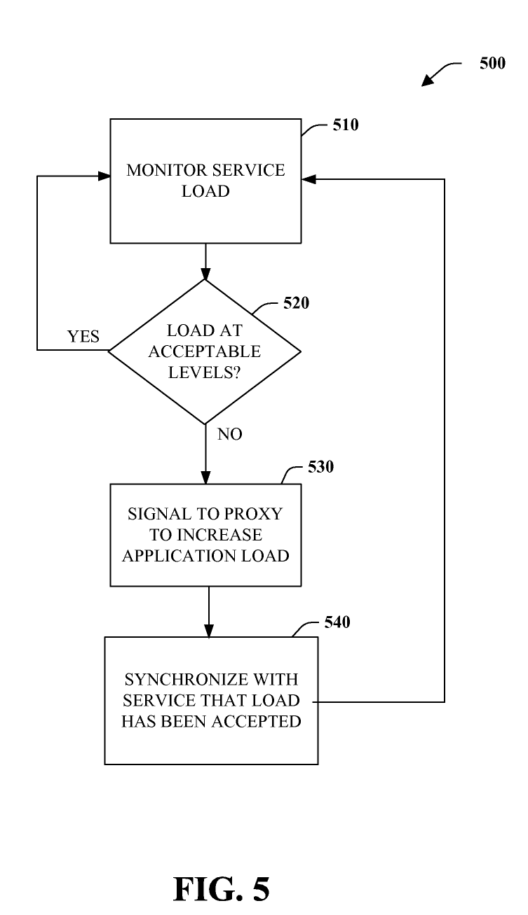

Referring to FIG. 5, a flow diagram illustrates a load balancing process 500 between a service and service proxy application. Proceeding to 510 of the process 500, application load is monitored at the service end. This can include monitoring service load in view of hundreds or thousands of remote proxy applications that may be employing the service for some aspect of service processing. At 520, a determination is made as to whether or not the load for the respective service is at acceptable levels. This can include monitoring performance of a parameter such as CPU load, available memory, or other parameter and checking whether such parameter is at an acceptable threshold. If the parameters are within acceptable ranges at 520, the process proceeds back to 510 and continues to monitor overall application or service load. If the parameters are deemed not acceptable at 530, the process proceeds to 530.

At 530, a signal is sent out to one or more proxies that may be interacting with the respective service. Such signal or data packet can indicate to the proxies what type of execution responsibilities are needed to be assumed by the proxies. For example, a data packet may instruct one or more proxies to implement an additional processing function at the proxy while offloading such responsibility from the service. Thus, if the proxy were currently operating a small subset of service functionality, the proxy can be instructed to increase the number or type of functions that are performed at the proxy. At 540, a synchronization operation is performed with the service to indicate the load has been accepted. This can include receiving further data from the service that enables the proxy to execute and ultimately assume further responsibilities from the service.

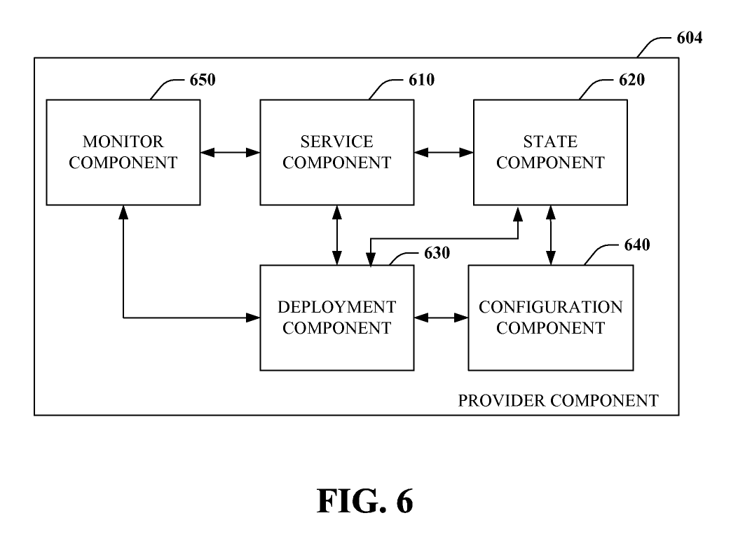

Turning to FIG. 6, a representative service provider component 604 is illustrated in accordance with an aspect of the claimed subject matter. The service component 604 includes a number of components that facilitate many modes of operation. In general, service component 610 and a state component 620 manage operation with respect to services and proxies, respectively. Deployment component 630 is a mechanism for deploying services as well as consumers, for example after communications have terminated. Configuration component 640 configures or optimizes services and/or consumers deployed by the deployment component 630. Finally, monitor component 650 monitors interaction and can initiate behind the scenes functionality. Components will now be discussed in further detail with respect to various modes of operation.

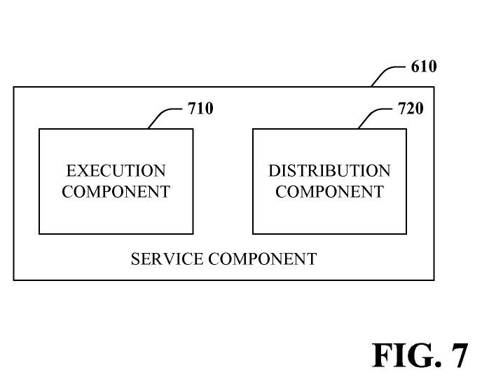

As previously described, proxy generation can be accomplished by swapping consumer and provider components, namely service and client functionality. Stated differently, the system transforms relationships from many to one (many clients and one service) to one to many (one client and many services). The service component 610 and state component 620 enable this functionality. As shown in FIG. 7, the service component 610 can include an execution component 710 and a distribution component 720 that distributes a service to one or more consumers for execution. Service distribution can trigger application of the proxy.

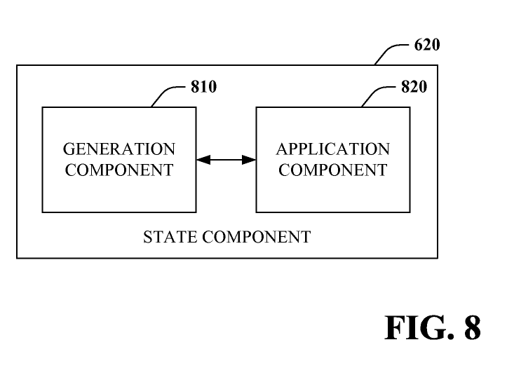

Referring briefly to FIG. 8, a representative state component 620 is illustrated in further detail in accordance with an aspect of the claimed subject matter. The state component 620 includes both a generation component 810 and an application component 820. The generation component 810 enables a client to be generated and/or modified. Each client can include a plurality of different applications of a service and associated communication path. The application component 820 applies to a service. As mentioned, this can be triggered by distribution of a service to a consumer, among other things. Applications or operations produce results that can be output for later use. It should be appreciated that subsequent to application, a client can be modified or regenerated utilizing generation component 810 and subsequently reapplied. This provides flexibility that is not available if the service and consumer are not swapped.

Returning to FIG. 6, after compilation is complete, the service and proxies can be deployed as usual utilizing deployment component 630. Deployment component 630 deploys the service on the provider and can provide service consumers to consumers. The service can be executed by an execution component 710 associated with the service component 610 depicted in FIG. 7. Furthermore, it is to be noted that the configuration component 640 can configure the service and/or the consumer in accordance with the results afforded by the state component 620. For example, where an error is identified in the service, the configuration component 640 can be employed to rectify the issue. Additionally or alternatively, the configuration component 640 can modify a service/proxy or consumer to optimize interaction and/or processing efficiency. For instance, where network connection speed is an issue, a lower bandwidth version of the application can be deployed.

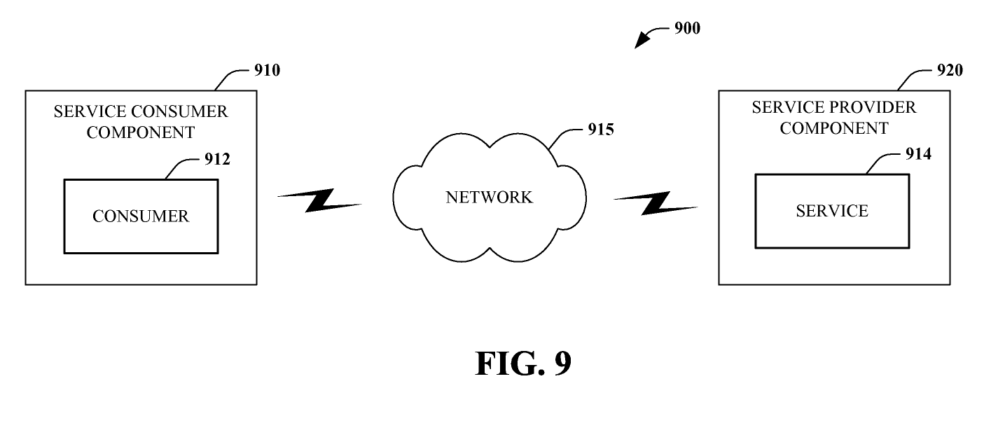

FIG. 9 depicts a deployed service system 900 in accordance with an aspect of the subject matter. Similar to system 100 of FIG. 1, the system 900 includes a service consumer component 910, network 915, and service provider component 920. Here, however, the service 914 resides on the service provider side. A service consumer 912 resides on the service consumer side as shown within the service consumer component 912. In other words, the service is deployed in a conventional consumer/provider architecture where the provider provides and the consumer consumes.

Turning attention back to FIG. 6, it is to be noted that monitor component 650 can influence if and when applications are executed. An application setting need not be set up explicitly. Applications can be performed behind the scenes with or without user knowledge. The monitor component 650 can identify an injection point to initiate other actions such as load balancing. For instance, the monitor component 650 can monitor a service executed by the service component 610 and initiate testing of yet another service through the service component 610 when available processing time is identified such as where it is determined or inferred that a user will spend some amount of time entering data for submission. This can be utilized to test or deploy new versions or features of the executing service or an entirely different service. This can be done with user permission (e.g., explicit permission, preferences, license agreement . . . ) and/or in more of a stealth mode.

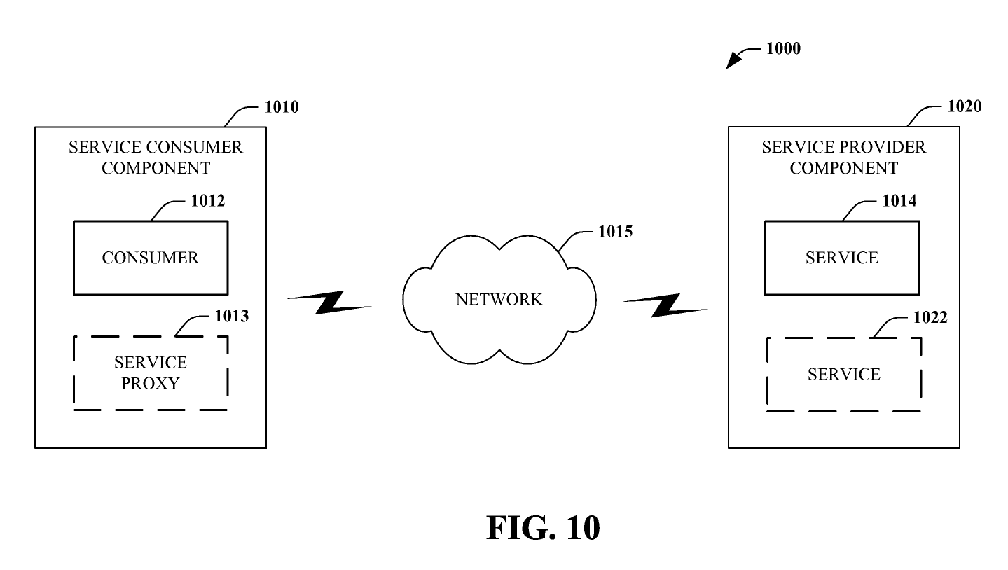

FIG. 10 illustrates a service system 1000 running multiple services in accordance with an aspect of the claimed subject matter. Similar to system 900 of FIG. 9, the system 1000 includes the service consumer component 1010 and service provider component 1020, where a consumer 1012 is interacting with a service 1014 across the network 1015. While this service is being utilized, the provider component 1020 can ship another service or proxy service component 1013 to the service consumer component 1010.

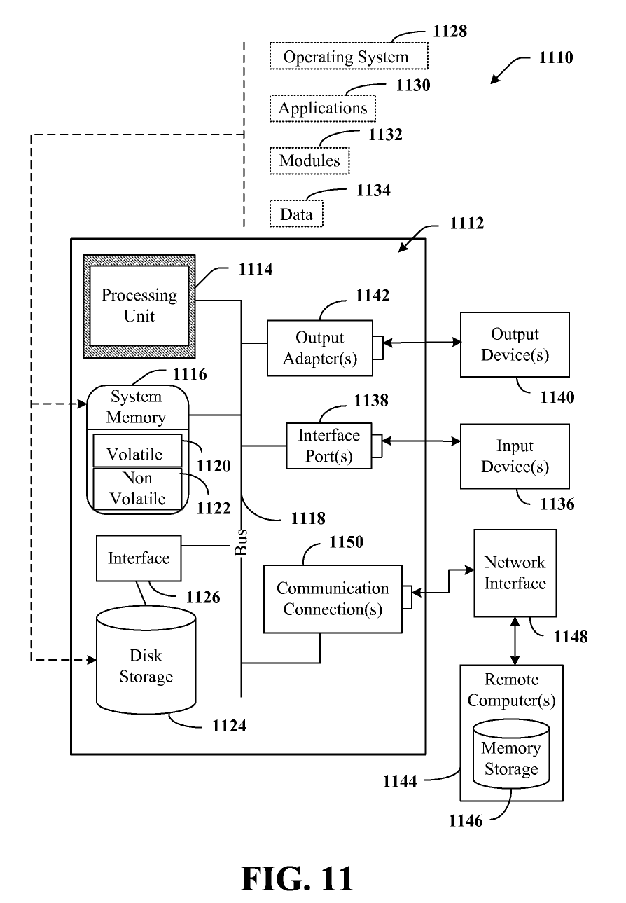

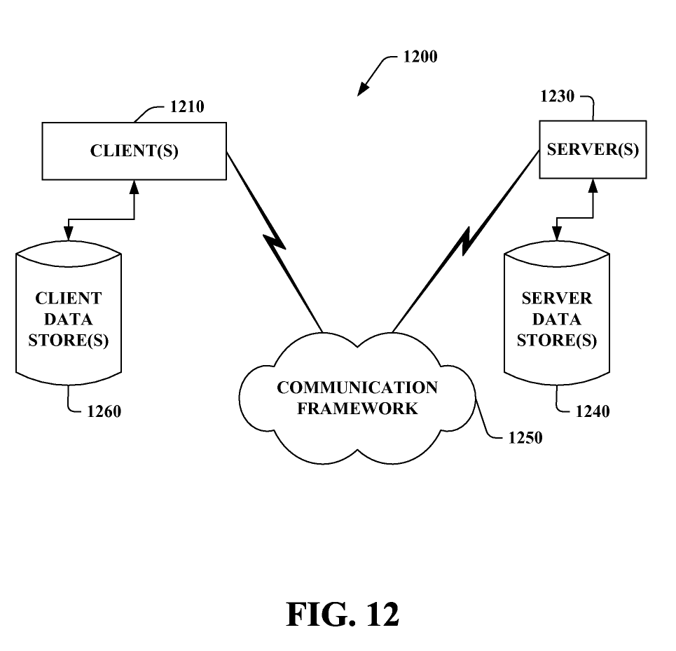

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 11, an exemplary environment 1110 for implementing various aspects described herein includes a computer 1112. The computer 1112 includes a processing unit 1114, a system memory 1116, and a system bus 1118. The system bus 1118 couple system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, 64-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable ROM (EEPROM), or flash memory. Volatile memory 1120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also includes removable/non-removable, volatile/non-volatile computer storage media. FIG. 11 illustrates, for example a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in suitable operating environment 1110. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that various components described herein can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112 and to output information from computer 1112 to an output device 1140. Output adapter 1142 is provided to illustrate that there are some output devices 1140 like monitors, speakers, and printers, among other output devices 1140 that require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

FIG. 12 is a schematic block diagram of a sample-computing environment 1200 that can be employed. The system 1200 includes one or more client(s) 1210. The client(s) 1210 can be hardware and/or software (e.g., threads, processes, computing devices). The system 1200 also includes one or more server(s) 1230. The server(s) 1230 can also be hardware and/or software (e.g., threads, processes, computing devices). The servers 1230 can house threads to perform transformations by employing the components described herein, for example. One possible communication between a client 1210 and a server 1230 may be in the form of a data packet adapted to be transmitted between two or more computer processes. The system 1200 includes a communication framework 1250 that can be employed to facilitate communications between the client(s) 1210 and the server(s) 1230. The client(s) 1210 are operably connected to one or more client data store(s) 1260 that can be employed to store information local to the client(s) 1210. Similarly, the server(s) 1230 are operably connected to one or more server data store(s) 1240 that can be employed to store information local to the servers 1230.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system to facilitate service-oriented applications, comprising:
one or more network accessible resources that are split into two or more application functions; and
a proxy component that communicates over a network with the one or more network accessible resources and executes a subset of the application functions during outages of the network, where the proxy component processes state information and data in conjunction with the application functions.

2. The system of claim 1, the one or more network resources are coordinated to form a service for the proxy component.

3. The system of claim 1, the one or more network resources are defined by declarative attributes in a source file.

4. The system of claim 3, the declarative attributes define one or more proxy components within the source file.

5. The system of claim 4, further comprising a multi-tiered application that is formed as at least one proxy component and at least one service component, the multi-tiered application generated when the declarative attributes are executed by a compiler.

6. The system of claim 1, further comprising one or more monitor components to determine whether a network is operating.

7. The system of claim 6, further comprising one or more switching components to signal operations have shifted from a service component to a proxy component t when a network becomes non-functional.

8. The system of claim 7, further comprising a synchronization component to exchange data and state information between the proxy component and the service component when the network resumes operations.

9. The system of claim 1, further comprising a distribution component to automatically load the proxy component at a client machine.

10. The system of claim 1, further comprising a monitoring component to determine available load capacity of a service.

11. The system of claim 10, further comprising a load balancing component to re-direct service operations to at least one proxy component.

12. The system of claim 1, further comprising a security component to hide interactions between a proxy component and a client component.

13. The system of claim 1, further comprising a configuration component to adjust operations or functionality of a proxy component or a service component.

14. The system of claim 1, further comprising a web browser to execute the proxy component.

15. The system of claim 14, the proxy component automatically caches data for the web browser and an associated service.

16. The system of claim 15, the proxy component automatically captures state for the web browser and an associated service.

17. A network applications method, comprising:
declaring attributes in a service file defining operations of the service;
declaring attributes in a service file defining operations of a proxy; and
automatically splitting an application between the service and the proxy based in part on the declared attributes.

18. The method of claim 17, further comprising automatically deploying the proxy to one or more client machines to interact with the service.

19. The method of claim 18, further comprising automatically synchronizing data between the proxy and the service.

20. A network communications system, comprising:
means for providing one or more services;
means for interacting remotely with the services; and
means for defining attributes of the services.
